(19) United States
(12) Patent Application Publication
(10) Pub. No.: US 2021/0184776 A1
(43) Pub. Date: Jun. 17, 2021

(54) LOW POWER RECEIVER APPARATUS

(71) Applicant: pureLIFi Limited, Edinburgh (GB)

(72) Inventors: Giorgio Antonino Vazzana, Edinburgh (GB); Mostafa Zaman Afgani, Edinburgh (GB)

(73) Assignee: pureLiFi Limited, Edinburgh (GB)

(21) Appl. No.: 16/770,450

(22) PCT Filed: Dec. 7, 2018
(86) PCT No.: PCT/GB2018/053563

§ 371 Date: Jun. 5, 2020

(30) Foreign Application Priority Data
Dec. 7, 2017 (GB) 1720440.5

(51) Int. Cl. H04B 10/61; H04B 10/11

(52) U.S. Cl. CPC H04B 10/616; H04B 10/11

(57) ABSTRACT

An optical wireless communication (OWC) receiver comprises: a photodetector device configured to receive light and to produce a detection signal in response to the received light; receiver circuitry configured to receive and process the detection signal to produce a receiver signal; signal processing circuitry configured to apply a decoding and/or demodulation process to the receiver signal in accordance with an OWC communication protocol thereby to extract data from the receiver signal; wake-up circuitry configured to monitor output from the photodetector device or the receiver circuitry, for a predetermined frequency or range of frequencies, and in response to the monitored output being indicative that the received light represents an OWC signal performing a wake-up procedure to move at least the signal processing circuitry from a first, lower power state to a second, higher-power state, wherein in the first lower power state the signal processing circuitry is configured to not perform said decoding and/or demodulating process to extract data from the receiver signal; in the second, higher power state the signal processing circuitry is configured to perform said decoding and/or demodulation process.

### INTRODUCTION

The present invention relates to an optical wireless communication receiver apparatus, in particular a low power receiver apparatus.

### BACKGROUND

It is known to provide wireless data communications by using light instead of radio frequencies to transmit and receive data wirelessly between devices. Data may be transmitted using light by modulating at least one property of the light, for example an intensity of the light. Methods that use light to transmit data wirelessly may be referred to as optical wireless communications (OWC) or light communications (LC).

In Optical Wireless Communication Systems (such as LiFi) the basic scenario involves a number of Access Points (AP) that communicates with a number of Stations (STA). Both the Access Points and the Stations are full duplex devices, capable of transmitting and receiving at the same time.

The AP is connected to the internet and provides both light and data. Each AP is able to communicate with multiple stations at the same time, efficiently sharing the connection between them. Stations are connected to computers via USB or other buses and provide full-duplex connectivity to the host. Stations can also move from one AP to another without losing their connection to the network (the handover is done in such a way that it looks like a seamless transition to the user).

In known OWC systems a station must be able to determine whether an AP is in range and/or when an AP is turned on and there is activity on an optical channel.

Known methods for determining whether an AP is in range include maintaining the station in a high power “on state” at all times, including its optical front end and base band apparatus, to monitor activity on the channel. This method may be inefficient and waste battery resources. Another known method is to periodically wake up a station to listen on a channel for possible activity and to maintain a low power mode at other times. However, using this method, parts of a data transmission may be missed and power may be wasted when the station is in an inefficient low power mode.

### SUMMARY

According to a first aspect of the present invention, there is provided an optical wireless communication (OWC) receiver comprising: a photodetector device configured to receive light and to produce a detection signal in response to the received light; receiver circuitry configured to receive and process the detection signal to produce a receiver signal; signal processing circuitry configured to apply a decoding and/or demodulation process to the receiver signal in accordance with an OWC communication protocol thereby to extract data from the receiver signal; wake-up circuitry configured to monitor output from the photodetector device or the receiver circuitry, optionally for a predetermined frequency or range of frequencies, and in response to the monitored output being indicative that the received light represents an OWC signal performing a wake-up procedure to move at least one of the receiver circuitry, part of the receiver circuitry and the signal processing circuitry from a first, lower power state to a second, higher-power state, in which the receiver circuitry is configured to perform said processing of the detection signal and/or in which the signal processing circuitry is configured to perform said decoding and/or demodulation process.

The wake-up procedure may be performed in response to the monitored output being indicative that the received light represents an OWC communication protocol signal. The wake-up procedure may be performed in response to the monitored output being indicative that the received light represents activity on an optical channel.

In the first, lower power state, the receiver circuitry may be configured to not perform processing of the detection signal. In the first, lower power state, the signal processing circuitry may be configured to not perform said decoding and/or demodulating process.

In the first lower power state the signal processing circuitry may be configured to not perform said decoding and/or demodulating process to extract data from the receiver signal. Said data may comprise data included in a payload portion and/or in a header portion of a message according to the OWC protocol.

The photodetector may be a single photodetector or a plurality of photodetectors. The plurality of photodetectors may be arranged in an array or in a matrix. One or more of the plurality of photodetectors may be a low-power photodetector.

The plurality of photodetectors may be arranged such that one or more low-power photodetectors is positioned centrally in the plurality of photodetectors. The one or more low-power photodetectors may be positioned in the centre of an array of photodetectors.

The plurality of photodetectors may be arranged such that one or more low-power photodetectors is positioned at the periphery of the plurality of photodetectors. The one or more low-power photodetectors may be positioned at one or more edges of an array of photodetectors or at one or more corners of an array of photodetectors.

The wake-up circuitry may be configured to monitor for the presence of a signal having at least one predetermined property, optionally at least one amplitude and/or frequency and/or duration signature and/or energy. The signal may have at least one predetermined property comprises a sinusoidal signal and/or a binary phase shift keying (BPSK signal).

The signal may have at least one predetermined property comprises at least one tone having a threshold amplitude and/or duration. The OWC communication protocol may use a predetermined frequency range and the at least one tone may be toward the lower frequency end of the frequency range and/or toward the higher frequency end of the frequency range.

The OWC communication protocol may encode data as a sequence of symbols on carriers and/or sub-carriers, and the monitoring for the presence of the signal having at least one predetermined property may comprise monitoring for the presence of at least one carrier and/or sub-carrier.

The monitoring for the presence of a signal having the at least one predetermined property may comprise monitoring for the presence of at least one of a pilot signal or data signal or according to the OWC communication protocol.

The at least one predetermined property may comprise a property derived from the OWC communication protocol and determined independently of the wake-up procedure and/or the signal having at least one predetermined property may be not a dedicated wake-up signal.

The wake-up circuitry may be configured to monitor the output from the photodetector device or the receiver circuitry, and to determine whether the monitored output is indicative that the received light represents an OWC communication protocol signal without performing a decoding process according to the OWC communication protocol.

The wake-up circuitry may be tuned to monitor for activity on different channels. The wake-up circuitry may be configured to monitor more than one channel simultaneously. The wake-up circuitry may be configured to block monitoring of one or more channels depending on location or user or time of day.

The wake-up circuitry may comprise further circuitry, for example further receiver circuitry or further signal processing circuitry.

The further circuitry may be configured to perform a partial or a simplified decoding and/or demodulating process, relative to said decoding and/or demodulation process of the signal processing circuitry, on the output from the photodetector device.

The wake-up circuitry may comprise at least one of: a bandpass filter and/or tone detector and/or transimpedance amplifier; a phase-locked loop;

The wake-up circuitry may comprise energy detection circuitry for detecting energy level at a predetermined frequency or range of frequencies, optionally wherein the range of frequencies corresponds to a predetermined number of sub-carriers according to the OWC communication protocol.

The energy detection circuitry may be configured to compare the detected energy level to a threshold and to determine whether the received light represents an OWC communication protocol signal in dependence on the comparison.

The decoding circuitry may be included in a baseband chip and the wake-up procedure comprises moving the baseband chip from a first, lower power state to a second, higher-power state.

The wake-up procedure may further comprise moving at least one of an amplifier and an analogue-to-digital converter from a first, lower power state to a second, higher-power state.

The receiver may form part of a combined, radio frequency, RF, and OWC communication apparatus and the wake-up procedure further comprises switching from receiving and/or transmitting data using an RF communication protocol to receiving and/or transmitting data using the OWC communication protocol by the combined RF and OWC communication apparatus.

At least one of the receiver circuitry and signal processing circuitry may have at least one further operating state in addition to the lower power state and higher power state. The receiver circuitry and/or signal processing circuitry may be configured to move to said further operating state in dependence on at least one property an OWC signal represented by the received light. The further operating state may comprise an operating state that has a different power consumption level than the higher or lower power states. The further operating state may be a state that provided different demodulation or decoding functionality than the higher or lower power operating states.

The OWC communication protocol may comprise an orthogonal frequency division multiplexing (OFDM) protocol.

The light may comprise at least one of visible, infra-red or ultraviolet light.

The OWC communication protocol may comprise a LiFi communication protocol and/or an OWC communication protocol supporting full duplex communication.

According to a second aspect of the present invention, which may be provided independently, there is provided an optical wireless communication (OWC) method comprising: receiving, by a photodetector device, light and producing, by the photodetector device, a detection signal in response to the received light; providing receiver circuitry configured to receive and process the detection signal to produce a receiver signal; providing signal processing circuitry configured to apply a decoding and/or demodulation process to the receiver signal in accordance with an OWC communication protocol thereby to extract data from the receiver signal; monitoring, by wake-up circuitry, output from the photodetector device or the receiver circuitry, optionally for a predetermined frequency or range of frequencies, and in response to the monitored output being indicative that the received light represents an OWC signal performing a wake-up procedure to move the at least one of the receiver circuitry, part of the receiver circuitry and the signal processing circuitry from a first, lower power state to a second, higher-power state, and performing, by the receiver circuitry in the second, higher-power state, said processing of the detection signal and/or performing, by the signal processing circuitry in the second, higher-power state, said decoding and/or demodulation process.

Features in one aspect may be applied as features in any other aspect, in any appropriate combination. For example, device features may be provided as method features or vice versa.

### BRIEF DESCRIPTION OF THE DRAWINGS

Various aspects of the invention will now be described by way of example only, and with reference to the accompanying drawings, of which:

FIG. 1 is a schematic diagram of a transmitter and receiver using optical wireless communication;

FIG. 2 is a schematic diagram of an optical wireless communication receiver apparatus;

FIG. 3 is a schematic diagram of a photodetector array;

FIG. 4 is a schematic diagram of a typical receiver apparatus chain;

FIG. 5 is a schematic diagram of an embodiment of an optical wireless communication receiver;

FIG. 6 is a schematic diagram of a further embodiment of an optical wireless communication receiver, and

FIG. 7(a) is a plot illustrating an orthogonal frequency division multiplexing channel in the frequency domain and FIG. 7(b) is a plot illustrating an orthogonal frequency division multiplexing burst signal in the time domain.

### DETAILED DESCRIPTION OF THE DRAWINGS

The term light herein may be used, for example, to refer to electromagnetic waves with wavelengths in a range 1 nm to 2500 nm, which includes ultraviolet, visible light and near-infrared wavelengths.

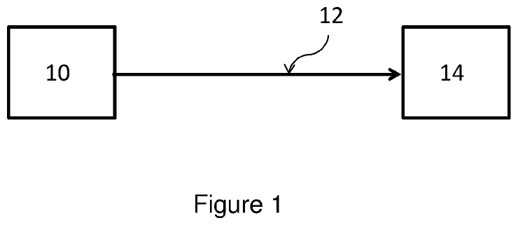

FIG. 1 is a schematic block diagram illustrating principles of optical wireless communication according to embodiments. FIG. 1 shows a transmitter apparatus 10 and a receiver apparatus 14. The transmitter apparatus 10 is configured to send wireless optical signals in which information is encoded through an optical communication channel 12 to the receiver apparatus 14. The optical communication channel 12 may be a free-space communication channel. The optical communications channel 12 has a characteristic optical wavelength.

Free space communication channels include transmission of optical signals through air, space, vacuum, liquid such as water or similar.

Transmitters and receivers may be provided on different devices. One type of device that is used is an access point. Access points may provide access to a further network. Another type of device is a station. Stations may be portable or fixed. Without limitation, examples of stations include personal computers, desktops, laptops and smart devices, including mobile devices. Portable stations may be powered by their own battery resource.

An access point may provide data transmission to and/or from a wired network or a W-Fi or other wireless network and/or other optical wireless communications network, optionally a LiFi network.

The transmitter apparatus 10 includes a light emitting diode (LED), laser or other suitable light source, and an associated driving circuit to drive the LED or laser to produce the optical signal. The associated driving circuitry includes a digital to analogue convertor configured to provide a modulation signal at a frequency characteristic of an optical light communication signal. A further processor, provided as part of the transmitter apparatus or associated with the transmitter apparatus, modulates data onto a drive current and the driving circuitry provides the drive current to the LED or laser. The LED or laser then produces an outgoing modulated optical wireless communication signal that carries the data.

The receiver apparatus 14 includes a photodiode, or other suitable light detector, with associated circuitry to condition any received signal. The photodiode converts received light to an electronic signal which is then conditioned by the conditioning circuitry. Conditioning may include one or more filter steps; amplification of a weak electrical signal; equalisation of received signals and converting the analogue signals into digital signals using an analogue to digital convertor. The digital signals can then be provided to a further processor, provided as part of the receiver apparatus or associated with the receiver apparatus, to be demodulated to extract communication data. An example of a typical receiver apparatus is described in more detail with reference to FIG. 4 where the conditioning circuitry and further processor correspond to an optical front end module and a baseband processor resource.

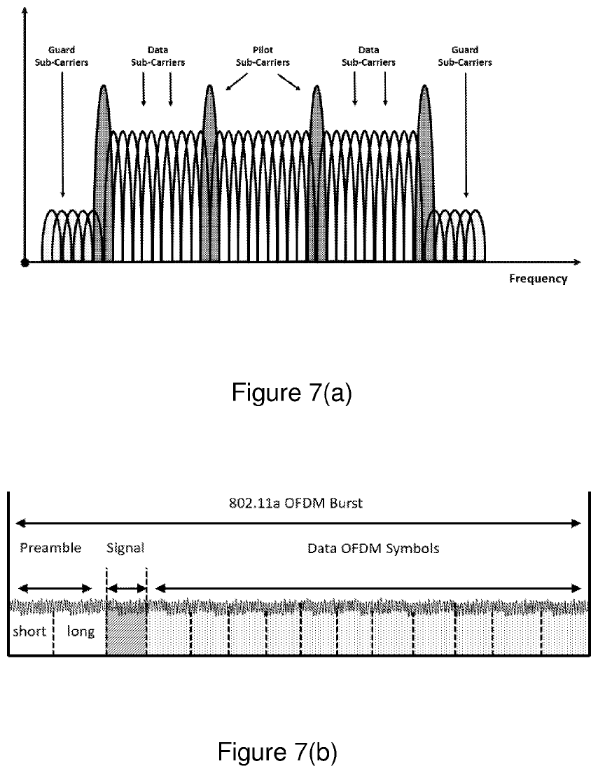

Any suitable modulation scheme may be used, for example orthogonal frequency division multiplexing (OFDM) modulation schemes are used in some embodiments, and the demodulation is a demodulation from the OFDM modulation scheme. OFDM modulation is described in further detail with reference to FIG. 7. In some embodiments, other modulation schemes may be used. The modulation scheme may form part of an OWC communication protocol, such that the optical signal is produced according to the OWC communication protocol. The OWC communication protocol may for example be a packet-based protocol. The OWC communication protocol may send messages including header and payload portions in accordance with known techniques.

In known transmitter and receiver pairs, the receiver apparatus 14 is switched on and may continually receive light, even when out of range of the transmitter apparatus 10 and/or when the transmitter apparatus 10 is not sending optical signals and/or when the transmitter apparatus 10 is switched off. This may prove to be a drain and/or inefficient use of battery resources of, or associated with, the receiver apparatus.

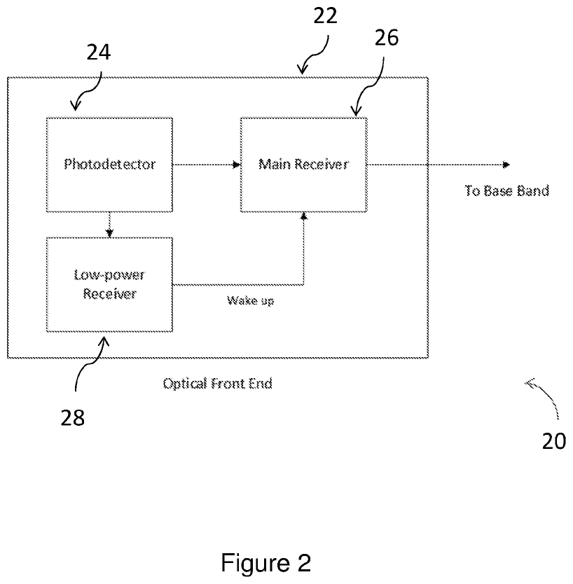

FIG. 2 is a schematic diagram of an optical wireless communication receiver apparatus 20 provided in accordance with embodiments. The receiver apparatus 20 has an optical front end 22. The optical front end 22 has a photodetector 24, a main receiver optical front end apparatus, for brevity referred to as main receiver module 26, and a low power optical front end apparatus, for brevity referred to a low-power receiver module 28. The optical front end 22 is in communication with a base band apparatus (not shown).

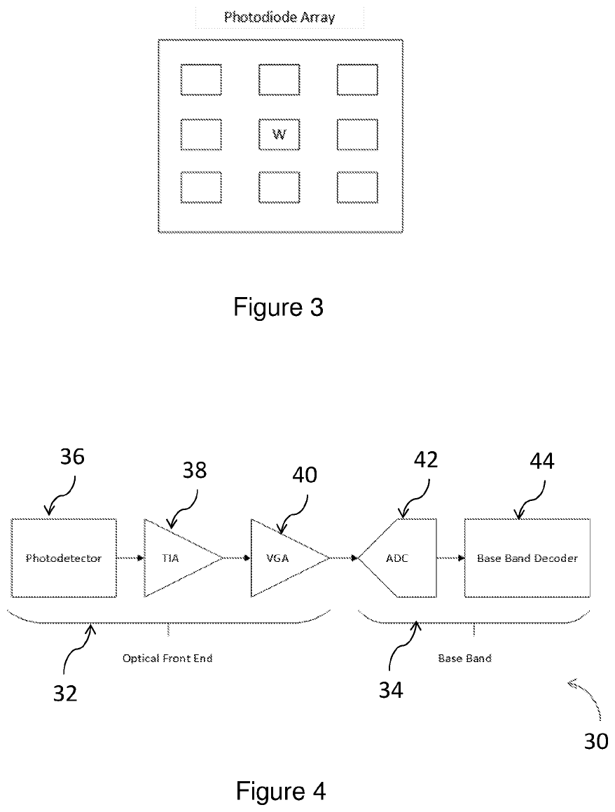

The low-power receiver module 28 may also be referred to as a wake-up module or wake-up circuitry. The low-power receiver module 28 is provided to monitor output from the photodetector 24 and to perform a wake-up procedure on the main receiver module 26 when the monitored output is indicative that there is activity on the optical channel. Further details of the components used and arrangements of the photodetector 24, the main receiver module 26, the low-power receiver module 28 are provided with reference to FIGS. 3, 4, 5 and 6.

The photodetector may be one of: a PIN diode, an Avalanche Photo Diode (APD), a Silicon Photomultiplier (SiPM) or similar. Although referred to as a photodetector, the photodetector can be a single photodetector or a plurality of photodetectors. In some embodiments, the plurality of photodetectors are arranged in an array or a matrix.

The photodetector 24 is configured to receive light and convert the received light into an electronic detection signal. The main receiver module 26 and the low-power receiver module 28 are arranged to be in electrical communication with the photodetector 24 such that detection signals can be received by the main receiver module 26 and the low-power receiver module 28.

The main receiver module 26 is a high performance receiver configured to receive electrical signals from the photodetector 24 and pass these electrical signals to the base band apparatus for demodulating. The main receiver module 26 processes the detection signal from the photodetector to produce a receiver signal. Processing of the detection signal includes conditioning, which may include one or more filter steps; amplification of a weak electrical signal and/or equalisation of received signals. The base band apparatus is configured to receive an analogue receiver signal and perform an analogue to digital conversion process before performing a demodulating process. Therefore the main receiver module 26 produces and transmits an analogue receiver signal.

The low power receiver 28 is configured to perform a monitoring process on detection signals from the photodetector 24 and perform a wake-up procedure on the main receiver module 26 based on the monitoring process. The low power receiver 28 is configured to monitor the detection signals from the photodetector 24 for the presence of a signal having at least one predetermined property of the detection signals. In some embodiments, low power receiver 28 is configured to monitor the detection signals from the photodetector 24 for the presence of at least one amplitude and/or frequency and/or duration signature in the detection signals. Monitoring for the presence of the signal having at least one predetermined property may comprise monitoring for the presence of at least one carrier and/or sub-carrier.

Presence of the at least one predetermined property in the output of the photodetector allows the low-power receiver module 28 to establish that there is activity on the optical channel or at least that there is an indication that activity is on the optical channel. In some embodiments, the signal having at least one predetermined property may comprise a sinusoidal signal and/or a binary phase shift keying (BPSK signal). In some embodiments, the signal may comprise at least one tone that has a value of amplitude above a predetermined threshold amplitude value. In some embodiments, the signal may comprise at least one tone that has a value of duration above a predetermined threshold duration value.

As described above, different modulation schemes may be used for optical wireless communication. These modulation schemes may be categorised as single-carrier or multi-carrier. Single carrier schemes include On-Off keying, pulse width modulation, pulse amplitude modulation. Multi-carrier modulation schemes include orthogonal frequency division multiplexing (OFDM). Different variants of optical OFDM may be used to achieve a unipolar OFDM output.

Without reference to a specific modulation scheme, a sub-carrier of a multi-carrier scheme may be selected to carry a wake-up tone. For example, a pilot or data sub-carrier can be selected to carry a wake-up tone. The sub-carrier may be selected to carry a sinusoidal signal and/or a binary phase shift keying (BPSK).

In some embodiments, the wake-up tone can be allocated to a sub-carrier toward a lower end of the signal bandwidth. In that case, a low-bandwidth, low-power receiver can be used to detect the tone. Alternatively, or in addition, a wake-up tone can be allocated to a sub-carrier toward a higher end of the signal bandwidth. In this case, information about the speed of the channel can be extracted. By allocating a wake up signal towards the higher end of the signal bandwidth, the channel has to incorporate lower frequency information. Therefore, frequency of the wake-up subcarrier gives you information of the minimum channel bandwidth.

No demodulation of the received optical signal is necessary to determine if there is activity on the optical channel. Therefore, one or both of the base band apparatus and the main receiver module 26 can remain turned off or in a low power operating state while channel activity is probed. Because the low-power receiver 28 comprises simple low-power components (see specific embodiments described later), in contrast to the high performance components of the main receiver module 26 and/or base band apparatus, battery life may be improved.

In some embodiments, no additional modification or additional modulation of the optical signal is required at the transmitter end and the predetermined property is part of the modulated optical signal. In some embodiments, there is no requirement for additional modification or additional modulation of the optical signal beyond the modulation already required for optical communication and the at least one property is related to the choice of modulation scheme used for the optical signals. The property may be at least one carrier or a sub-range of frequencies having an amplitude or duration above a certain value. The carrier may be one or more sub-carriers. The sub-carrier(s) may be pilot sub-carriers or data sub-carriers.

In other embodiments, additional modulation may be performed on the optical signal at the transmitter end such that the at least one predetermined property is included in the transmitted optical signal. For example, a wake-up tone can be modulated onto the optical signal in addition to the communication data. In these embodiments, further simple demodulation/decoding circuitry is provided to demodulate or decode the optical signal to retrieve the wake-up tone.

The low power receiver 28 is configured to perform a wake up process on the main receiver module 26. In addition or alternatively, in some embodiments, the low power receiver is configured to perform a wake up process on the base band processor. In some embodiments, the low power receiver 28 is configured to send instruction signals to the main receiver 26 based on the received detection signals and/or based on the monitoring process of the received detection signals. The main receiver module 26 is therefore configured to receive the instruction signals and to perform an action based on the instructions.

The main receiver 26 module is configured to be in one or more operating states. In some embodiments, the one or more operating states correspond to a lower power state and a higher power state. In some embodiments, the one or more operating states correspond to an on and an off state.

In other embodiments, the one or more operating states correspond to a range of different states. In some embodiments, the one or more operating states may include one or more lower power states for short range transmission and/or low data rate transmission. Alternatively, or in addition, the one or more operating states may include one or more higher power states for long range transmission and/or high data rate transmissions.

In some embodiments, the instructions transmitted from the low-power receiver include a wake-up instruction that changes the operating state of the main receiver, for example, a wake-up instruction that prompts the main receiver module 26 to change from a low-power operating state to a higher power operating state. If the main receiver 26 has different operating states available the instruction then can include a change operating state instruction that prompts the main receiver module 26 to change an operating state.

In some embodiments, for a main receiver module 26 that comprises a receiver chain having a plurality of different blocks, the one or more operating states may comprise a power state configuration of the main receiver module 26 such that operating states of the different blocks of the main receiver module 26 can be controlled independently. In this case, a set of instructions may be transmitted to the receiver module 26 that includes different instructions for the different components of the receiver module 26.

In some embodiments, the different components of the receiver module 26 may have different operating states. The one or more operating states of the components of the receiver module may include short range/long range operating states and/or low data rata/high data rate operating states.

For clarity, the operation of the apparatus of FIG. 2 is described for only two operating states of the main receiver module 26: a first operating state which correspond to the main receiver module 26 being in a low-power “sleep” mode and a second higher power operating state which corresponds to the main receiver module 26 being in a higher power “awake” mode. As described above, other operating states and configurations are possible.

For the purposes of the description of operation, the main receiver module 26 is considered to be initially in its sleep mode. In a room with ambient or other light, light is incident on a surface of the photodetector 24 and therefore received by the photodetector 24 and converted into detection signals. The light may comprise optical signals. In sleep mode, the main receiver module 26 is configured to not receive the detection signals. In sleep mode, the main receiver 26 is configured to not process the detection signals to produce receiver signals. In sleep mode, the base band apparatus does not receive receiver signals and perform a demodulation process. The detection signals of the photodetector are monitored continuously by the low-power receiver module 28. The low-power receiver module 28 receives the detection signals or part of the detection signals and determines whether the received light is representative or indicative of activity on the optical channel.

If low-power receiver module 28 determines there is activity on the channel then a wake-up signal is sent to the main receiver module 26 to change the operating mode of the main receiver module 26 from sleep mode to awake mode. If low-power receiver module 28 determined that there is no activity on the channel then no signal is sent.

In the awake mode, in a room with ambient or other light, light is incident on a surface of the photodetector 24 and therefore received by the photodetector 24 and converted into detection signals. In the awake mode, the main receiver 26 receives the detection signals and processes the detection signals to produce receiver signals. The receiver signals are then sent to the baseband processing resource (not shown) to be demodulated. The baseband processing resource then performs a demodulating process. The baseband processing resource may be provided on a baseband processing chip. At least two of the photodetector, the optical front end and the baseband processing resource may be provided as part of the same chip.

The main receiver module 26 and/or baseband processing resource may be returned to its sleep mode automatically, in response to no communication signals being received or following a period of time during which no communication signals are received.

In some embodiments, a control signal from an external source is used to control the operating state of the main receiver module 26 and/or baseband processing resource. The main receiver module 26 and/or baseband processing resource may be returned to its sleep mode using a control signal from an external source (not shown). The control signal may be generated in response to a CPU of the device indicating that the battery resource is running low or a security risk identified. The control signal may be generated manually by a user.

Although FIG. 2 shows the low-power circuitry configured to change the operating state of a main receiver module 26 that comprises optical front end components, the low power receiver may alternatively or in addition be connected to the base band apparatus and the low power receiver configured to send instructions to the base band apparatus to change the operating states of blocks of the base band apparatus. These blocks include base band decoding circuitry and analogue to digital convertors.

Although FIG. 2 shows the low-power circuitry receiver 28 provided to monitor output from the photodetector 24, in some embodiments, the low-power receiver circuitry 28 may be provided to monitor output from the main receiver 26. In these embodiments, the low-power receiver circuitry 28 is configured to perform a wake-up process on the base band apparatus based on the monitoring the output from the main receiver 26.

As described above, in some embodiments, a plurality of photodetectors, for example, an array of photodiodes may be provided. One or more photodetectors of the array may differ from the other photodetectors of the array in at least one of: size, technology or other parameters. Each photodetector of the array may be provided with dedicated circuitry and/or a dedicated optical front end and/or a dedicated baseband processing resource.

In some embodiments, one of the photodetectors may be a low-power photodetector. In some embodiments, the plurality of photodetectors includes one main photodetector and one small, low-power, photodetector for low-power monitoring. In the example array shown in FIG. 3, the middle photodetector is marked by a “W” and is surrounded by photodetectors. When an array of photodetectors is provided as shown in FIG. 3, only the detection signal from the low-power photodetector is monitored by low-power receiver module. In some embodiments, the low-power receiver module 28 may be configured to perform a wake-up process on the other, non low-power, photodetectors.

By including an array of photodetectors, one or more photodetectors may be dedicated to low-power monitoring and/or be kept switched on for wake-up until the system is woken up. The function of photodetectors may be varied from wake-up monitoring to full signal reader.

FIG. 3 shows an array of photodetectors arranged such that a low-power photodetector is positioned in the centre of the array. In other embodiments, one or more low-power photodetectors may be positioned at the periphery of the plurality of photodetectors. For example, an array of photo-detectors may be provided as shown in FIG. 3 but with four low-power photodetectors provided at the four corners of the square array and photodetectors configured for data signal reception at the other five positions including the central position. This arrangement may provide better coverage of the data signal.

Although two arrangements of photodetector arrays are described, it will be understood that other arrangements are possible. For example, as signal to noise ratio is dependent on area, in some embodiments, a subset of the photodetector array can be used for wake up signal detection and the whole array used for data collection. In some embodiments, the low-power photodetector may be a first type of photodetector, for example, a PIN photodiode and the other photodetectors may be a second type of photodetector, for example, a higher sensitivity avalanche photodiode (APD). In some embodiments, the low-power photodetector may be sensitive to light of a first wavelength or in a first range of wavelengths and the other photodetectors may be sensitive to light of a second, different, wavelength or light in a second, different, range of wavelengths. In some embodiments low-power photodetectors that are smaller than the other photodetectors are provided.

One or more filters may be provided as part of the photodetector array such that the low-power photodetectors have one or more filters of a first type and the other photodetectors have one or more filters of a second type. In some embodiments, the low-power photodetectors may be coupled to low power components and/or made from less sensitive technology. Less sensitive technology may be cheaper.

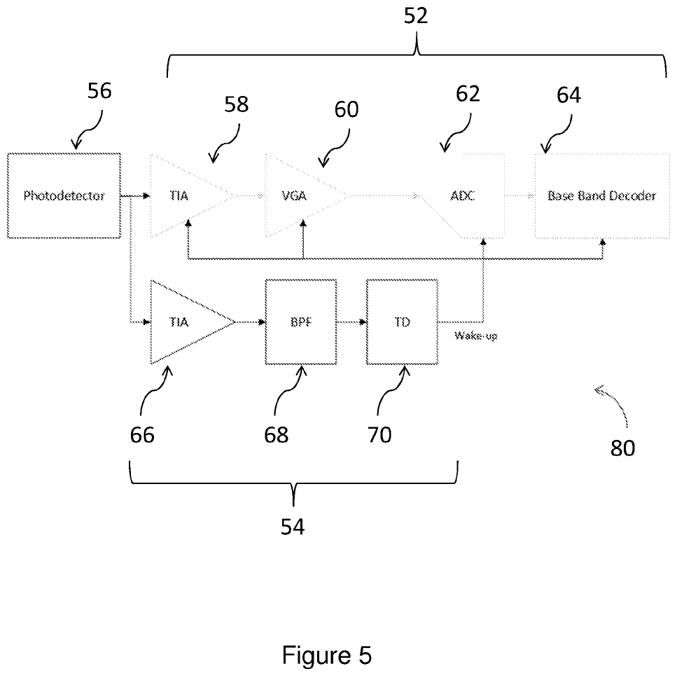

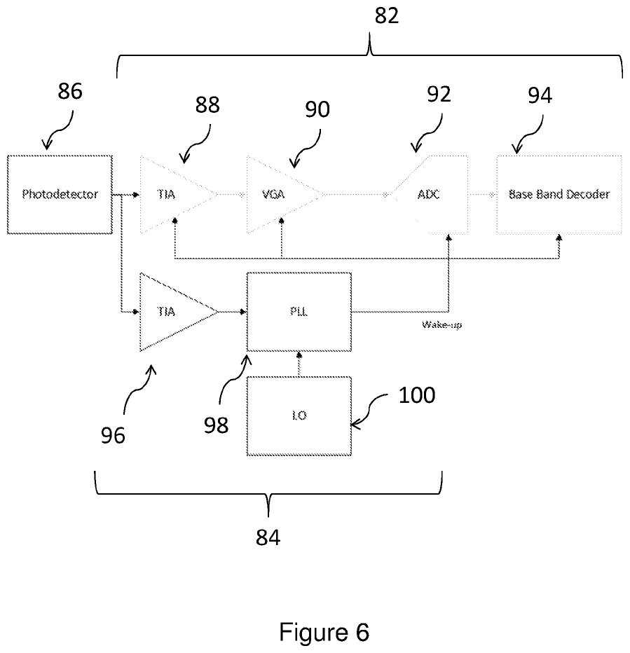

FIGS. 5 and 6 are provided to describe and outline a number of different embodiments of the receiver apparatus. Before describing receivers according to specific embodiments, a typical receiver apparatus and components thereof are described. FIG. 4 illustrates a typical receiver apparatus 30 for optical wireless communication, which may also be referred to as a receiver chain. The receiver apparatus 30 of FIG. 4 is comprised of a plurality of blocks, which may also be referred to as stages. These blocks are described with reference to FIG. 4 and are known standard components of a typical receiver apparatus 30. When provided in the embodiments of FIG. 5 and FIG. 6, these components perform substantially the same function as in FIG. 4.

The receiver apparatus 30 has an optical front end 32 and a base band processing resource 34. The optical front end 32 is configured to detect light and optical wireless communication signals carried by light and produce electrical receiver signals based on the detected light. The base band processing resource 34 is configured to receive the receiver signals and extract data from the receiver signals.

In known receiver chains, such as the one illustrated in FIG. 4, channel activity detection is performed by the base band apparatus 34. This may lead to unnecessary power consumption. In known receiver chains, to detect activity on an optical communication channel, all blocks of the receiver chain must be powered on, either all the time or periodically, and the base band processing resource 34 and components thereof are continually performing packet detection on sample data to establish if a valid packet is being transmitted on the optical channel.

In further detail, the optical front end 32 has the following components or blocks: a photodetector 36, a trans-impedance amplifier 38, also referred to as a TIA, and a variable gain amplifier 40, also referred to as a VGA. The base band apparatus 34 has the following components or blocks: an analogue to digital convertor 42 and a base band decoder 44.

The photodetector 36 is configured to receive light and convert light into an electronic signal, in this case, the photodetector 36 receives light and produces a current signal. The trans-impedance block is provided to convert the current signal from the photodetector to a voltage signal. The trans-impedance block 38 may be incorporated or integrated into the photodetector 36 itself.

The VGA block 40 is configured to introduce a variable gain into the receiver chain. The VGA block 40 is configured to condition the voltage signal from the trans-impedance block 38 so that the voltage signal input to the ADC 42 is as close as possible to the maximum input range of the ADC 42. The VGA block 40 may allow an increased or maximised signal to noise ratio to be achieved.

The ADC 42 converts the input analogue voltage to digital signals. The digital signal comprises digital samples with a fixed or variable sample rate and fixed or variable resolution. The samples are processed by the base band decoder 44 to demodulate and/or decode signals to extract data.

FIG. 4 shows a typical receiver chain used for receiving light, conditioning detection signals and decoding receiver signals. It will be understood that FIG. 4 is illustrative of a typical chain only and other blocks or components may be provided in a receiver chain.

FIG. 5 and FIG. 6 shows optical wireless communication receivers provided in accordance with embodiments. These two embodiments are configured for use with an OFDM-type modulation scheme. However, these embodiments may be used with other modulation schemes, in particular any other suitable modulation scheme that has one or more sub-carriers with different central sub-carrier frequencies. For illustrative purposes a brief description of OFDM-type modulation is provided here.

FIG. 7(a) illustrates an OFDM channel in the frequency domain and FIG. 7(b) illustrates a OFDM signal burst in the time domain. Orthogonal frequency division multiplexing is realized using a plurality of orthogonal sub-carriers in the frequency domain. As can be seen from FIG. 7(a), OFDM uses a frequency range and the frequency range is divided into a fixed number of sub-carriers (these may also be referred to as sub-channels). Each sub-carrier may be characterised by its width or sub-carrier frequency range. Each sub-carrier is modulated with a conventional modulation scheme.

A single OFDM symbol is made up of an IFFT transform of the modulated signals of the sub-carriers to the time domain. The OFDM signal is the sum of a plurality of OFDM symbols, each comprising orthogonal subcarriers, with baseband data on each subcarrier being individually modulated using quadrature amplitude modulation (for example, using one of 16-QAM or 64-QAM) or phase shifting modulation (for example, using BPSK, QPSK or 8PSK). In known standard schemes, there are 52 orthogonal subcarriers but the number of orthogonal subcarriers can vary in different schemes.

As shown in FIG. 7(a), sub-carriers can be pilot sub-carriers, data sub-carriers or null (or guard) sub-carriers. Pilot sub-carriers can be used for control, equalization, configuration, synchronisation purposes. In contrast to other modulation schemes, no guard intervals need to be provided between data sub-carriers and pilot sub-carriers because of orthogonality ensuring that there is no interference between sub-carriers.

An example of a typical time domain waveform for an OFDM signal burst is shown in FIG. 7(b). An OFDM frame is composed of a number of training symbols followed by a number of OFDM data symbols. FIG. 7(b) shows a short training sequence following by a long training sequence. These two training sequences make up a preamble or synchronisation part of the frame.

Returning to FIG. 5, a schematic diagram of an optical wireless communication receiver apparatus 80 shown, in accordance with embodiments. The apparatus 80 has a main receiver module 52 and a low-power receiver module 54 and a photodetector 56. Main receiver module 52 has the following blocks, that are provided and operate as described with reference to FIG. 4: TIA block 58, VGA block 60, ADC block 62 and base band decoder block 64. In addition, photodetector 56 is provided as described with reference to FIGS. 2 and 4, optionally as described with reference to FIG. 4. Low-power receiver module 54 has the following blocks: a secondary TIA block 66, a band-pass filter block 68, also referred to as BPF and a tone detector 70, also referred to as TD.

Secondary TIA block 66 is configured to convert a current signal from the photodetector to a voltage signal and to amplify the voltage signal to produce an output signal. The BPF 68 is configured to receive a signal and to permit part of the signal having a frequency in a sub-range of frequencies to pass through and to block and/or substantially attenuate parts of the signal that have a frequency outside the sub-range of frequencies. The range of frequencies that are permitted is pre-determined. In some embodiments, this range may be varied.

The tone detector block 70 is configured to receive an input analogue signal and produce a high quality digital signal when the power of the input analogue signal is above a threshold. The low-energy module blocks are arranged in order of TIA block 66, BPF block 68 and TD block 70 such that output from TIA block 66 is input into BPF block 68 and output from BPF block 68 is input into the TD block 70.

The BPF 68 has a central frequency that is selected to match a frequency of a sub-carrier or the middle frequency of a number of subcarriers of the OFDM signal. For example, the central frequency may be the frequency of one of the pilot sub-carriers or a data sub-carrier.

In operation, all blocks of the main receiver module 52 are in a low-power state. Light is received by photodetector 56 to produce a detection signal. Secondary TIA block 66 of the low-power receiver module 54 receives the electrical detection signal and conditions the signal by converting from current to voltage, and, optionally, amplifying the signal. The conditioned signal is then transmitted by the secondary TIA 66 to the BPF 68. Only a part of the detection signal that has a frequency equal to the central frequency of the BPF 68 pass through the BPF and are transmitted to the TD block 70. The tone detection block 70 produces a high digital output when the power of the tone is above a pre-defined threshold.

The TD block 70 performs a comparison between the amplitude of the signal that has passed through to a threshold amount. If the amount of signal that passes through and thus the amount of signal that has a frequency substantially equal to the BPF central frequency, is above the threshold, then a digital signal is produced. The digital signal is transmitted to the components of the main receiver 52 thereby changing their operational state from low power to high power. In the high power state, the components of the main receiver 52 are configured to start receiving and conditioning the detection signals to produce receiver signals and also to start decoding and/or to demodulate the receiver signals.

FIG. 6 is a schematic diagram of an example embodiment of the optical wireless communication receiver. The embodiment has a main receiver module 82 and a low-power receiver module 84 and a photodetector 86. Main receiver module 82 has the following blocks, that are provided as described with reference to FIG. 2 and FIG. 6: TIA block 88, VGA block 90, ADC block 92 and base band decoder block 94. In addition, photodetector 86 is provided as described with reference to FIGS. 2 and 4, optionally as described with reference to FIG. 4.

Low-power receiver module 84 has the following blocks: secondary TIA block 96, phase locked loop 98, also referred to as PLL and local oscillator 100, also referred to as LO.

Secondary TIA block 96 is configured to convert a current signal from the photodetector to a voltage signal and to amplify the voltage signal to produce an output signal. The phase locked loop 98 is configured to receive two input signals and generate an output voltage. The local oscillator 100 is configured to provide the PLL 98 with an oscillating signal.

The blocks of the low-power receiver module 84 are arranged such that the phase locked loop 98 compares the output from the TIA 96 with the oscillating signal of the local oscillator 100, and tries to lock the phase of the two signals, that is to null the phase difference between them. The blocks are arranged such that the lock range is narrow and centred about a frequency of a tone to be detected. The digital lock signal from the PLL 98 essentially represents the channel activity binary state.

In operation, all blocks of the main receiver module 82 are in a low-power state. Light is received by photodetector 86 to produce a detection signal. Secondary TIA block 96 of the low-power receiver module 84 receives the electrical detection signal and conditions the signal by converting from current to voltage, and, optionally, amplifying the signal. The conditioned signal is then transmitted by the secondary TIA 96 to the PLL 98. The PLL 98 and LO 100 cooperate to produce a signal from the PLL 98 that represents channel activity and corresponds to a wake-up signal for the components of the main receiver module.

The digital signal is transmitted to the components of the main receiver 82 thereby changing their operational state from low power to high power. In the high power state, the components of the main receiver 82 are configured to start receiving and conditioning the detection signals to produce receiver signals and also to start decoding and/or demodulating the receiver signals.

Another example embodiment is presented and is based on detecting energy in a frequency range. In this embodiment, additional energy detection circuitry is provided for detecting energy levels at a frequency or in a range of frequencies corresponding to one or more sub-carries of the OFDM signal.

The additional energy detection circuitry has filtering circuitry configured to filter signals in a frequency or in a range of frequencies and an energy collector and/or integrator configured to collect and/or integrate energy over a number of sub-carriers. The average energy present in one or more sub-carriers of the signal is compared to a threshold energy level and a determination is made that the average energy present is higher than the threshold energy level. In response, to determining that the average energy present is higher than a threshold energy, a wake-up signal is sent to at least one of a main processing module and a baseband processing resource. In some embodiments, a determination is made average energy present is significantly higher than the threshold energy level.

A skilled person will appreciate that variations of the enclosed arrangement are possible without departing from the invention. Accordingly, the above description of the specific embodiment is made by way of example only and not for the purposes of limitations. It will be clear to the skilled person that minor modifications may be made without significant changes to the operation described.

1. An optical wireless communication (OWC) receiver comprising:
a photodetector device configured to receive light and to produce a detection signal in response to the received light;
receiver circuitry configured to receive and process the detection signal to produce a receiver signal;
signal processing circuitry configured to apply a decoding and/or demodulation process to the receiver signal in accordance with an OWC communication protocol thereby to extract data from the receiver signal;
wake-up circuitry configured to monitor output from the photodetector device or the receiver circuitry, for a predetermined frequency or range of frequencies, and in response to the monitored output being indicative that the received light represents an OWC signal performing a wake-up procedure to move at least the signal processing circuitry from a first, lower power state to a second, higher-power state, wherein
in the first lower power state the signal processing circuitry is configured to not perform said decoding and/or demodulating process to extract said data from the receiver signal;
in the second, higher power state the signal processing circuitry is configured to perform said decoding and/or demodulation process.

2. The receiver according to claim 1, wherein the wake-up procedure is performed in response to the monitored output being indicative that at least one of:
the received light represents an OWC communication protocol signal; or
the received light represents activity on an optical channel.

3. The receiver according to claim 1, wherein the wake up procedure further comprises moving the receiver circuitry or part of the receiver circuitry from a lower power state to a higher power state.

4. The receiver according to claim 1, wherein in the first, lower power state the receiver circuitry is configured to not perform processing of the detection signal.

5. The receiver according to claim 1, wherein the photodetector comprises a plurality of photodetectors, optionally, wherein the plurality of photodetectors are arranged in an array or matrix.

6. The receiver according to claim 5, wherein at least one of the plurality of photodetectors is a low-power photodetector.

7. The receiver according to claim 1, wherein the wake-up circuitry is configured to monitor for the presence of a signal having a predetermined property, and at least one of amplitude, frequency, duration signature or energy.

8. The receiver according to claim 7, wherein the signal having a predetermined property comprises at least one of a sinusoidal signal or a binary phase shift keying (BPSK signal).

9. The receiver according to claim 7, wherein the signal having a predetermined property comprises a tone having at least one of a threshold amplitude or a threshold duration.

10. The receiver according to claim 9, wherein the OWC communication protocol uses a predetermined frequency range and the tone is at least one of toward the lower frequency end of the frequency range or toward the higher frequency end of the frequency range.

11. The receiver according to claim 7, wherein the monitoring for the presence of a signal having the predetermined property comprises monitoring for the presence of at least one of a pilot signal or data signal according to the OWC communication protocol.

12. The receiver according to claim 7, wherein the predetermined property may comprise a property derived from the OWC communication protocol and at least one of determined independently of the wake-up procedure, or the signal having the predetermined property is not a dedicated wake-up signal.

13. The receiver according to claim 1, wherein the wake-up circuitry is configured to monitor the output from the photodetector device or the receiver circuitry, and to determine whether the monitored output is indicative that the received light represents an OWC communication protocol signal without performing a decoding process according to the OWC communication protocol.

14. The receiver according to claim 1, wherein at least one of:
the wake-up circuitry is tuneable to monitor for activity on different channels;
the wake-up circuitry is configured to monitor more than one channel simultaneously; or
the wake-up circuitry is configured to block monitoring of one or more channels depending on location or user or time of day.

15. The receiver according to claim 1, wherein the wake-up circuitry comprises further circuitry.

16. The receiver according to claim 15, wherein the further circuitry is configured to perform a partial or a simplified decoding and/or demodulating process, relative to said decoding and/or demodulation process of the signal processing circuitry, on the output from the photodetector device.

17. The receiver according to claim 1, wherein the wake-up circuitry comprises at least one of:
a bandpass filter and/or tone detector and/or transimpedance amplifier; or
a phase-locked loop.

18. The receiver according to claim 1, wherein the wake-up circuitry comprises energy detection circuitry for detecting energy level at a predetermined frequency or range of frequencies, optionally wherein the range of frequencies corresponds to a predetermined number of sub-carriers according to the OWC communication protocol.

19. The receiver according to claim 18, wherein at least one of:
the energy detection circuitry is configured to compare the detected energy level to a threshold and to determine whether the received light represents an OWC communication signal in dependence on the comparison; or
the energy detection circuitry comprises an energy collector and/or integrator.

20. The receiver according to claim 1, wherein the decoding circuitry is included in a baseband chip and the wake-up procedure comprises moving the baseband chip from a first, lower power state to a second, higher-power state.

21. The receiver according to claim 1, wherein the wake-up procedure further comprises moving at least one of an amplifier or an analogue-to-digital converter from a first, lower power state to a second, higher-power state.

22. The receiver according to claim 1, forming part of a combined, radio frequency, RF, and OWC communication apparatus and the wake-up procedure further comprises switching from receiving and/or transmitting data using an RF communication protocol to receiving and/or transmitting data using the OWC communication protocol by the combined RF and OWC communication apparatus.

23. The receiver according to claim 1, wherein at least one of the receiver circuitry or signal processing circuitry has at least one further operating state in addition to the lower power state and higher power state, and the receiver circuitry and/or signal processing circuitry is configured to move to said further operating state in dependence on a property an OWC signal represented by the received light.

24. The receiver according to claim 1, wherein the OWC communication protocol comprises an orthogonal frequency division multiplexing (OFDM) protocol.

25. The receiver according to claim 1, wherein the light comprises at least one of visible, infra-red or ultraviolet light.

26. The receiver according to claim 1, wherein the OWC communication protocol comprises a LiFi communication protocol and/or an OWC communication protocol supporting full duplex communication.

27. An optical wireless communication (OWC) method comprising:
receiving, by a photodetector device, light and producing, by the photodetector device, a detection signal in response to the received light;
providing receiver circuitry configured to receive and process the detection signal to produce a receiver signal;
providing signal processing circuitry configured to apply a decoding and/or demodulation process to the receiver signal in accordance with an OWC communication protocol thereby to extract data from the receiver signal;
monitoring, by wake-up circuitry, output from the photodetector device or the receiver circuitry, for a predetermined frequency or range of frequencies, and in response to the monitored output being indicative that the received light represents an OWC signal performing a wake-up procedure to move the at least the signal processing circuitry from a first, lower power state to a second, higher-power state, and
performing, by the receiver circuitry in the second, higher-power state said decoding and/or demodulation process, wherein
the method comprises not performing said decoding and/or demodulating process to extract data from the receiver signal when in the first, lower-power state.
